(19) United States
(12) Patent Application Publication
(10) Pub. No.: US 2026/0270563 A1
(43) Pub. Date: Sep. 10, 2026

(54) METHOD AND DEVICE FOR SETTING A RECEIVING UNIT FOR CARRYING OUT AN INSPECTION OF AN OBJECT

(71) Applicant: TOP seven GmbH & Co. KG, München (DE)

(72) Inventors: Oliver NEUBAUER, Starnberg (DE); Anand PATEL, München (DE); Rattakorn YORKSILA, Tutzing (DE)

(73) Assignee: TOP seven GmbH & Co. KG, München (DE)

(21) Appl. No.: 19/557,173

(22) Filed: Mar. 5, 2026

Related U.S. Application Data
(63) Continuation of application No. PCT/EP2024/074655, filed on Sep. 4, 2024.

(30) Foreign Application Priority Data
Sep. 5, 2023 (DE) 102023208549.6

(51) Int. Cl. H04N 23/71; G06T 7/00; G06V 10/60; G06V 10/82; G06V 20/10; G06V 20/17; H04N 23/60; H04N 23/74

(52) U.S. Cl. CPC H04N 23/71; G06T 7/0002; G06V 10/60; G06V 10/82; G06V 20/17; G06V 20/176; H04N 23/64; H04N 23/74; G06T 2207/10032; G06T 2207/20084; G06T 2207/30184

(57) ABSTRACT

Embodiments according to the present invention include a method for adjusting a recording unit for performing an inspection of an object, comprising: providing an optical reference recording which has been generated by using the recording unit and which contains at least part of the object to be inspected and an environment of the object; detecting the object within the optical reference recording; determining brightness information based on at least one portion of the reference recording, said at least one portion comprising at least one sub-portion of the object; determining an inspection illumination setting for the recording unit by using the brightness information.

Corresponding apparatuses are also disclosed.

### CROSS-REFERENCE TO RELATED APPLICATIONS

This application is a continuation of copending International Application No. PCT/EP2024/074655, filed Sep. 4, 2024, which is incorporated herein by reference in its entirety, and additionally claims priority from German Application No. 10 2023 208 549.6, filed Sep. 5, 2023, which is also incorporated herein by reference in its entirety.

Embodiments include methods and apparatuses for adjusting a recording unit for performing an inspection of an object.

Further, embodiments include methods and apparatuses for object inspection using object-based brightness histograms.

### BACKGROUND OF THE INVENTION

The inspection and maintenance of installations is an important building block for safe and efficient operation. Inspections, in particular for very large and/or not easily accessible objects or installation parts, involve some challenges.

Large installations are usually located outdoors, and so visual inspections in particular are affected by the sometimes daily changing light conditions, e.g. due to changes in the weather conditions. It may not be possible, for reasons of safety or economic viability, to arbitrarily postpone an appropriate inspection, or, for example, to repeatedly accept downtimes of such an installation that are required for inspection, e.g. when there are currently unfavorable light conditions. In addition, such installations, e.g. blades of wind turbines, must often be examined from a plurality of sides, and so unfavorable backlighting situations, for example, cannot be avoided.

Therefore, there is a need for a concept for inspecting an object, which concept makes it possible to perform the inspection as independently of the prevailing light conditions as possible, and to thereby achieve an improved tradeoff between robustness and accuracy and complexity and effort of the inspection.

### SUMMARY

According to an embodiment, a method for adjusting a recording unit for performing an inspection of an object may have the steps of: providing an optical reference recording which has been generated by using the recording unit and which contains at least part of the object to be inspected and an environment of the object; detecting the object within the optical reference recording; determining brightness information based on at least one portion of the reference recording, said at least one portion including at least one sub-portion of the object; determining an inspection illumination setting for the recording unit by using the brightness information.

According to another embodiment, an apparatus for adjusting a recording unit for performing an inspection of an object may have:
an evaluation unit which is configured
to obtain an optical reference recording which has been generated by using a recording unit and which contains at least part of the object to be inspected and an environment of the object;
to detect the object within the optical reference recording;
to determine brightness information based on at least one portion of the reference recording, said at least one portion including at least one sub-portion of the object; and
to determine an inspection illumination setting for the recording unit by using the brightness information.

Another embodiment may have a non-transitory digital storage medium having a computer program stored thereon to perform the inventive method when said computer program is run by a computer.

Embodiments according to the present invention include a method for adjusting a recording unit for performing an inspection of an object, comprising: providing an optical reference recording which has been generated by using the recording unit and which contains at least part of the object to be inspected and an environment of the object; detecting the object within the optical reference recording; determining brightness information based on at least one portion of the reference recording, said at least one portion comprising at least one sub-portion of the object, and determining an inspection illumination setting for the recording unit by using the brightness information.

The inventors have recognized that, for the purposes of an object inspection, setting an inspection illumination setting by means of brightness information based on a portion of the reference recording, which portion comprises the object or at least part of it, allows more meaningful inspection results, and a corresponding inspection method performed using the inspection illumination setting is more robust with regard to environmental influences on the light conditions.

Setting illumination parameters, such as an aperture or an illumination time, based on pixels of the object in the reference recording makes it possible to set the illumination such that the image parts of an inspection recording generated by using the inspection illumination setting that are relevant to the inspection have sufficiently good brightness with regard to the object features to be checked. This is made possible by detecting the object within the optical reference recording.

In particular, it is therefore possible to avoid overexposure or underexposure of the object to be inspected due to particularly light or particularly dark parts of the image which comprise, for example, a background of the object. Thus, good inspection results can be achieved even in difficult backlighting situations.

According to an embodiment, the object has an optically capturable object characteristic, such as a color, a pattern and/or a color pattern; and the inspection illumination setting for the recording unit is determined using the brightness information and the object characteristic.

The object characteristic can be, for example, an object-specific, a priori known (e.g. due to prior knowledge about an installation to be inspected) property which can form an input variable (e.g. for manual input) of a corresponding method according to the invention. For example, such an object characteristic can also be stored in a program according to the invention, that is to say, e.g. a computer program. For example, it can be taken into account that a blade of a wind power installation is red (e.g.: =dominant color channel of the object in the reference recording), or at least predominantly red, and so the evaluation of the brightness focuses on the red color component in the image, that is to say is performed with a focus, for example. For example, a histogram associated with the reference image for a corresponding color channel, e.g. red, can be optimized with respect to illumination settings to the effect that a recording of the same scene, under identical or similar conditions, has sufficient brightness of the corresponding color channel for inspection purposes.

Thus, an improvement or optimization of illumination settings can be adjusted to individual object properties in order to thus enable meaningful and robust inspections.

According to an embodiment, the method further comprises detecting the optically capturable object characteristic by means of the optical reference recording.

The method can thus also be automated with regard to the detection of the object characteristic, wherein, for example, an algorithm, e.g. AI, can detect an object, e.g. a blade of a wind turbine, and, based on the position in the image, can determine the object characteristic, by means of or with the aid of which the inspection illumination setting can be determined.

According to an embodiment, the brightness information comprises information about a brightness distribution, e.g. a histogram, of the at least one portion of the reference recording, and the method further comprises determining at least one brightness threshold value based on the object characteristic, and determining the inspection illumination setting for the recording unit using the brightness information and the at least one brightness threshold value, so that an inspection recording of the object, which is generated by using the recording unit with the inspection illumination setting in an identical or at least similar lighting situation of the object to that for the reference recording, has a brightness distribution which satisfies the brightness threshold value.

It should be noted here that in particular a plurality of brightness threshold values can also be used, e.g. in the sense of upper and lower limits, e.g. each specific to a respective object characteristic.

Thus, a brightness threshold value can be determined individually for a respective object based on the respective object characteristic and, based on this, for example from preliminary tests, or based on information about defects or damage to be detected, a meaningful inspection result can be achieved with sufficient certainty using an inspection recording generated by means of the inspection illumination setting.

According to an embodiment, the method is a method for adjusting a recording unit for performing an inspection of the object with respect to an object feature to be optically detected, and the determination of the at least one brightness threshold value based on the object feature to be detected is performed in such a way that the object feature to be detected can be detected by means of the inspection recording of the object.

Thus, a corresponding object feature, e.g. a characteristic point of the object, e.g. a blade tip or a rotor blade hub of a wind power installation, or for example damage, such as a crack or hole, can be reliably detected. Based on the object feature to be detected, the inspection illumination setting can thus be optimized, or detectability of the object feature can form a corresponding optimization criterion, e.g. for generating or selecting a corresponding brightness threshold value.

According to an embodiment, the object feature is damage and/or potential damage to the object. The setting according to the invention of the illumination has advantages, in particular for safety-critical applications, e.g. the detection of defects, due to a robust inspection based thereon that is largely independent of environmental influences.

According to an embodiment, the optically capturable object characteristic is a color, a color pattern and/or a color distribution of the object, the optical reference recording comprises a plurality of color channels, the brightness information is color-specific information about a brightness distribution, and determining the at least one brightness threshold value comprises determining one or more color-specific brightness threshold values. The inventors have recognized that a color-channel-specific consideration of brightness information for determining the inspection illumination setting can lead to better inspection results.

According to an embodiment, to determine the brightness information, all pixels of the object in the optical reference recording and/or a contiguous subset of pixels of the object in the optical reference recording and/or a predetermined pattern of pixels of the object in the optical reference recording is/are used.

The brightness information can be evaluated, for example, in the form of a histogram. In addition, the inventors have recognized that, depending on the object and/or feature to be detected, the inspection illumination setting or, as an intermediate step, a brightness threshold value can be determined in the course of the inspection, for example based on all object points or only a selected subset. Due to an application-specific clever choice of points to be evaluated, computing power can be saved, e.g. in particular if a corresponding evaluation is performed on-board in a drone which can record, for example, reference and inspection images during a flight. In addition, in some application cases, it is possible to improve a significance of the brightness information with regard to optimization for an inspection if not all points of the object are taken into account, e.g. not those points that represent portions of no interest for the inspection.

According to an embodiment, the optical reference recording is based on a reference illumination setting of the recording unit, and the determination of the inspection illumination setting for the recording unit is performed using the brightness information and at least one brightness threshold value. Further, as optional features, the method includes comparing the brightness information with the at least one brightness threshold value, wherein, if the brightness information complies with the at least one brightness threshold value, the reference illumination setting is determined as the inspection illumination setting, and wherein, if the brightness information does not comply with the at least one brightness threshold value, the steps of
determining an adjusted reference illumination setting using the comparison;
generating an adjusted reference recording in order to simulate generation of the reference recording using the adjusted reference illumination setting;
determining adjusted brightness information based on at least one portion of the adjusted reference recording, said at least one portion comprising at least one sub-portion of the object; and comparing the adjusted brightness information with the at least one brightness threshold value;
are performed iteratively until the adjusted brightness information complies with the at least one brightness threshold value, wherein the adjusted reference illumination setting, by means of which the brightness threshold value is complied with, is then determined as the inspection illumination setting.

Thus, the illumination setting can be adjusted iteratively, e.g. based on a simulated representation of the scene of the adjusted reference image (i.e. the reference recording). Further, the adjusted reference recording can, however, also be based on a new representation of the object, and in particular of the scene of the original reference recording, by means of the recording unit, e.g. in other words a recording device.

According to an embodiment, the object is a first object, the optical reference recording comprises a second object, and the method further includes detecting the second object within the optical reference recording, determining second brightness information based on at least one portion of the reference recording, said at least one portion comprising at least one sub-portion of the second object, determining a second inspection illumination setting for the recording unit by using the second brightness information, generating a first optical inspection recording of the first object by using the recording unit with the inspection illumination setting, and generating a second optical inspection recording of the second object by using the recording unit with the second inspection illumination setting.

This also makes it possible to scan a plurality of objects in each case with improved or optimized illumination settings in order to achieve a meaningful inspection. Such an adjustment can therefore be performed, for example, starting from a single image of the two objects. The two objects can thus each be scanned in separate recordings with individual illumination settings. Thus, even with a multitude of objects to be inspected, it is not necessary to create a separate reference image for each object. At this point, however, it should also be explicitly pointed out that the previous explanations with regard to two objects should be interpreted as examples. According to embodiments, any number of objects can also be detected and, for example, appropriately adjusted illumination settings can be determined in each case.

According to an embodiment, the method further comprises fusing the first and second optical inspection recording.

For example, the first object can thus be cut out from the first optical inspection recording and/or the second object can be cut out from the second optical inspection recording and inserted into a common recording (e.g. into the reference image, e.g. into the first inspection recording, e.g. into the second inspection recording), so that the two objects are each represented with sufficient brightness for an inspection within the fusion image. Various possibilities for fusion are possible here; embodiments are not limited to cutting out explained above. For example, the two inspection recordings can also be superimposed on a weighted basis. Based on the fusion image, an improved inspection is thus possible for both objects.

According to an embodiment, the object is a first object, the optical reference recording comprises a second object, and the method further includes detecting the second object within the optical reference recording; determining common brightness information based on the at least one portion of the reference recording, said at least one portion comprising at least one sub-portion of the first object, and based on at least one portion of the reference recording, said at least one portion comprising at least one sub-portion of the second object, determining a common inspection illumination setting for the recording unit by using the common brightness information; or determining second brightness information based on at least one portion of the reference recording, said at least one portion comprising at least one sub-portion of the second object, and determining a common inspection illumination setting for the recording unit by using the first and second brightness information, and generating an optical inspection recording of the first and second object by using the recording unit with the common inspection illumination setting.

According to embodiments, it is thus possible to use brightness information that represents a brightness of both the first (or parts of the first) and the second (or parts of the second) object, in order to determine, on the basis thereof, an illumination setting which can be used for both objects, e.g. in the sense of a meaningful inspection. For example, as explained above, it is possible to evaluate common brightness information, e.g. a common histogram, or two individual items of brightness information, e.g. histograms that respectively represent brightnesses of one object or the other.

The common inspection illumination setting can thus be a compromise, which is good enough for an inspection, in order to inspect a multitude of objects with a few image recordings.

According to an embodiment, the recording unit is a movable (e.g. mobile) recording unit, and the method further includes moving the recording unit to the object (for example approaching the object, e.g. with a recording unit in the form of a drone, e.g. the recording unit approaching the object, e.g. moving the recording unit to the object; e.g. moving the recording unit to a predetermined position with respect to the object (e.g. relative to the object)); generating the optical reference recording, and generating an inspection recording of the object by using the recording unit with the inspection illumination setting.

The reference recording and the inspection recording can be generated in separate approaches or within a single flight. Thus, the evaluation and determination of the improved illumination parametrization, can be performed by means of an external computer, for example during an intermediate landing, or during the flight on-board or by means of a data transfer to an appropriate external computer.

It should also be noted that, according to embodiments, the movable recording unit can be, for example, in the form of a portable, e.g. static or e.g. mobile, system or even e.g. in the form of another movable carrier system or carrier or may be part of such a system or may be moved by means of such a system.

According to an embodiment, the method further includes generating an initial recording of the object; detecting the object in the initial recording and evaluating the initial recording; determining a trigger point for the recording unit for generating the reference recording based on the evaluation of the initial recording so that the object is in a predetermined image portion of the reference recording; and positioning the recording unit at the trigger point (for example approaching the trigger point) and generating the optical reference recording of the object at the trigger point using the recording unit.

Thus, for example, it can be ensured that relevant object parts are located in a central image section, so that, for example, distortion effects in an edge portion can be avoided. Further, the image portion can be determined in such a way that a feature, such as damage, for which an inspection is intended to be performed, can be detected not only using a correct brightness setting, but also using a resulting resolution.

According to an embodiment, the detection of the object within the optical reference recording and/or the determination of the inspection illumination setting for the recording unit is/are performed in an automated manner, e.g. based on artificial intelligence. This makes it possible to achieve reliable and fast detection.

According to an embodiment, the detection of the object within the optical reference recording is performed by means of a first neural network, and the determination of the inspection illumination setting for the recording unit using the brightness information is performed by means of a second neural network.

The inventors have recognized that two-part use of artificial intelligence makes it possible to improve the achievable illumination settings, and so the first network can be set (or trained) for object detection and the second network can be set for optimizing the illumination.

It should be clearly pointed out that it is not mandatory, e.g. always, to use two neural networks (NN); there may also be only one (or e.g. no) neural network or there can be a plurality of neural networks. For example, it can only be significant that the needed steps can be decided.

It should be noted that, according to embodiments, a combination of computer vision (CV) and a neural network (NN) can also be used. For example, object detection can be performed by means of CV according to embodiments and/or brightness information can (e.g. also) be determined by means of CV.

Thus, embodiments include any combination (e.g. object detection +determination of the inspection illumination setting) of approaches of computer vision and machine learning (e.g. machine vision), e.g. neural networks, e.g.: CV+NN, CV+CV, NN+CV, NN+NN or CV only and NN only.

According to an embodiment, the object is a wind turbine or part of a wind turbine, such as a rotor blade, a rotor blade hub, a rotor blade flange, a tower and/or a nacelle.

The inventors have recognized that the problem of overexposure or underexposure occurs in particular in wind power installations, wherein the large installations that are often narrowly built in relation to the size (high tower heights with relatively small tower diameters, e.g. in comparison with a cooling tower of a power plant), since large parts of the background in the form of the sky, horizon and/or surrounding landscape can be seen in this case in a corresponding inspection recording, and thus backlighting situations can also occur, in particular. Also, such installations often do not stand out greatly from the background, e.g. white installation in front of a bright sky, and so inspections can be significantly improved by means of approaches according to the invention.

According to an embodiment, the method is a method for inspecting a component of a wind turbine with respect to optically detectable damage and/or potential damage, and the recording unit is a drone. Further, the method includes as optional features approaching the component of the wind turbine by means of the recording unit; generating an optical reference recording of the component of the wind turbine by means of the recording unit; automatically detecting the component of the wind turbine within the optical reference recording; determining a brightness distribution based on a subset of sampling points of the reference recording comprising the detected component of the wind turbine; and determining an inspection illumination setting for the recording unit using the brightness distribution so that damage and/or potential damage to the component of the wind turbine can be optically detected in an inspection recording of the component of the wind turbine, which is generated by using the recording unit with the inspection illumination setting in an identical or at least similar lighting situation of the component of the wind turbine to that for the reference recording.

Embodiments according to the present invention further include an apparatus for adjusting a recording unit for performing an inspection of an object, wherein the apparatus comprises an evaluation unit which is configured to obtain an optical reference recording which has been generated by using a recording unit and which contains at least part of the object to be inspected and an environment of the object; to detect the object within the optical reference recording; to determine brightness information based on at least one portion of the reference recording, said at least one portion comprising at least one sub-portion of the object; and to determine an inspection illumination setting for the recording unit by using the brightness information.

According to an embodiment, the apparatus comprises the recording unit which is configured to generate the optical reference recording.

According to an embodiment, the recording unit is a drone for flying over the object, and the recording unit is configured to perform the reference recording and an inspection recording of the object using the inspection illumination setting without an intermediate landing. This means that the time required can be kept to a minimum.

According to an embodiment, the recording unit comprises the evaluation unit or the apparatus comprises a communication unit which is configured to provide the evaluation unit with information about the optical reference recording from the recording unit and to provide the recording unit with information about the inspection illumination setting from the evaluation unit.

The apparatuses described above may be based on the same considerations as the methods described above. An apparatus according to an embodiment may comprise or be supplemented by all features, functionalities and details which are also described in relation to a method according to the invention, both individually and in combination. The same applies correspondingly to methods according to the invention with respect to features, functionalities and details disclosed with respect to an apparatus according to the invention.

### BRIEF DESCRIPTION OF THE DRAWINGS

Embodiments of the present invention will be detailed subsequently referring to the appended drawings, in which:

FIG. 1 shows a schematic view of object detection and schematic representations of optical recordings according to an embodiment of the invention;

FIG. 2 shows a recording of a rotor blade against a background in the form of the sky as an example of a reference recording according to embodiments of the invention;

FIGS. 3A-3D show schematic views of an object and a background of the object, FIG. 3A, a section of the view from FIG. 3A in FIG. 3B, as well as schematic plots of brightnesses of color channels for the view from FIG. 3A in FIG. 3C and for the view from FIG. 3B in FIG. 3D, according to embodiments of the invention; and

FIGS. 4A and 4B show schematic views of detection of a plurality of objects and schematic representations of optical recordings according to embodiments of the invention, with FIG. 4A showing the recording situation from FIG. 1, wherein the recording unit again makes a recording in a backlighting situation and FIG. 4B showing inspection recordings.

### DETAILED DESCRIPTION OF THE INVENTION

Before embodiments of the present invention are explained more specifically in detail below with reference to the drawings, it is pointed out that identical, functionally identical or identically acting elements, objects and/or structures in the different figures are provided with the same or similar reference signs, with the result that the description of these elements presented in different embodiments is interchangeable or can be applied to each other.

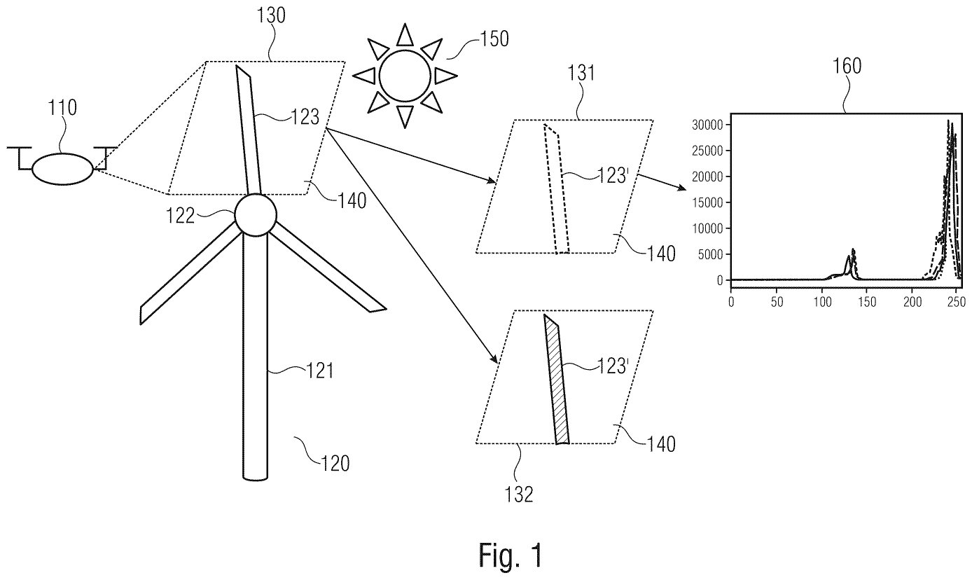

FIG. 1 shows a schematic view of object detection and schematic representations of optical recordings according to an embodiment of the invention. FIG. 1 shows a recording unit 110, as an example in the form of a drone, and an object 120, as an example in the form of a wind turbine having a tower 121, a rotor blade hub 122 and rotor blades 123.

The recording unit 110 is configured to generate a recording 130 of the object 120. In the example of FIG. 1, the recording unit 110 generates a recording of a rotor blade 123.

A method according to the invention now includes providing an optical reference recording 131 which has been generated by using the recording unit 110 and which contains at least part of the object 110 to be inspected (representation 123′ of the blade 123) and an environment 140 (or a representation of the environment) of the object.

As an example of a recording situation, FIG. 1 shows a constellation in which the recording unit 110 is confronted with backlighting 150. Therefore, in the reference recording 131, due to an unfavorable illumination situation, the object, or the representation 123′ of the object part, cannot clearly stand out from the environment 140, e.g. a bright horizon, with the result that a subsequent inspection cannot be performed or can be performed only with difficulty.

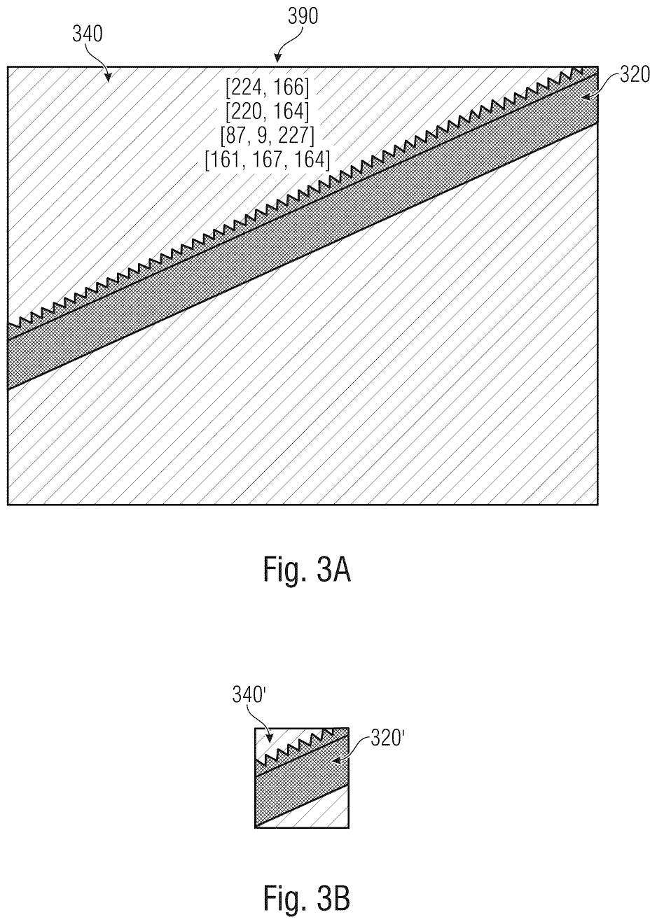

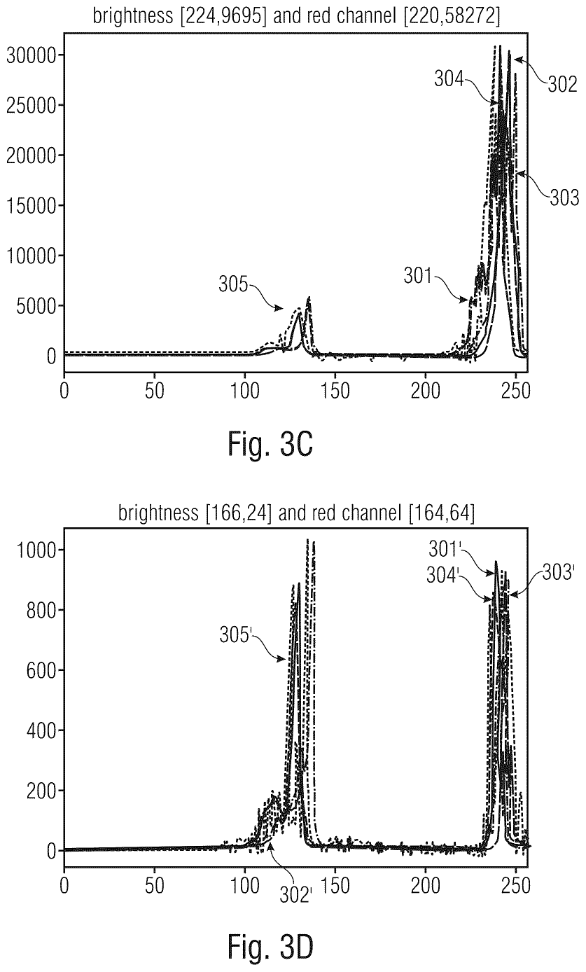

The method according to the invention now includes detecting the object (addressed in a simplified manner below with the representation 123′ of the object) within the optical reference recording 131 and determining brightness information 160, here as an example a histogram (see also in this regard, for example, the following FIGS. 3A-3D), based on at least one portion of the reference recording, said at least one portion comprising at least one sub-portion of the object, that is to say here the rotor blade 123.

This can be performed, for example, with an evaluation unit contained in the recording unit, or by means of communication to an external evaluation unit.

Based on the brightness information 160, an inspection illumination setting for the recording unit 110 can then be determined. The inspection illumination setting can then be used, for example, to generate an inspection recording 132 in which the illumination is set such that the object or the object part (i.e. the representation 123″ of the object part 123) stands out sufficiently clearly from the environment 140 to be able to perform a meaningful inspection (e.g. to also detect damage to the blade edges).

Optionally, the method thus includes, in other words, moving the recording unit 110 to the object 120 (e.g. approaching the object by means of the recording unit 110, e.g. positioning the recording unit near the object, e.g. at a predetermined position), generating the optical reference recording 131, and generating an inspection recording 132 of the object by using the recording unit with the inspection illumination setting. A reference image 131 and an inspection image can be generated, for example, during a single flight over the object, i.e. without an intermediate landing.

Accordingly, embodiments also further include an apparatus for adjusting the recording unit 110 for performing an inspection of the object 120, having an evaluation unit which is configured to obtain the optical reference recording 131 which has been generated by using the recording unit 110 and which contains at least part of the object 120 or 123 to be inspected and an environment 140 of the object. The evaluation unit (e.g. as part of the recording unit or in the form of an external computer, e.g. using a communication unit) is further configured to detect the object 120 or part 123 within the optical reference recording 131; to determine the brightness information 160 based on at least one portion of the reference recording, said at least one portion comprising at least one sub-portion of the object, and to determine an inspection illumination setting for the recording unit 110 by using the brightness information 160.

The recordings of the recording unit can include, for example, single images, or images of a video stream. Optionally, the detection of the object 123′ also within the optical reference recording 131 and/or the determination of the inspection illumination setting for the recording unit 110 can be performed in an automated manner, e.g. based on artificial intelligence.

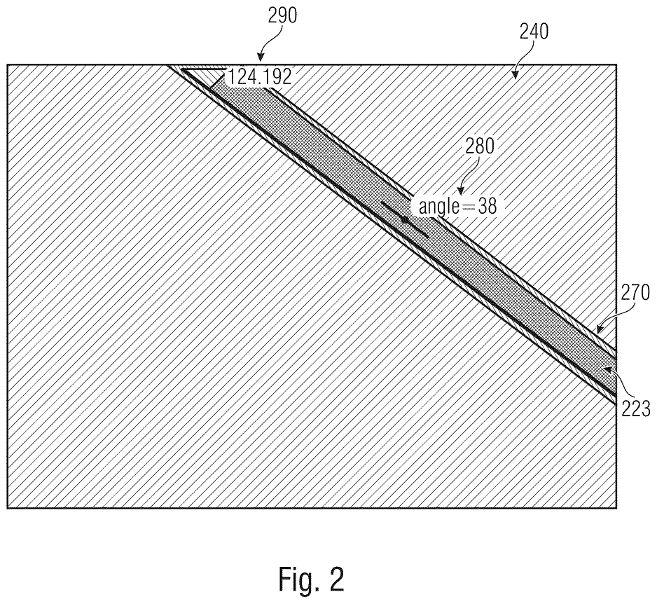

Optionally, the object 123 comprises a characteristic property, that is to say an object characteristic, on the basis of which the inspection illumination setting can be determined. FIG. 2 shows a recording of a rotor blade 223 (e.g. as an example of rotor blade 123) against a background 240 in the form of the sky, as an example of a reference recording according to embodiments. The rotor blade 223 has a red colored surface as a characteristic property. The object characteristic may also be, for example, a color combination or may also be, for example, a color pattern.

Such an object characteristic can be determined automatically, for example, by means of the object detection or may be provided as known prior information to the method as an input or as a parameter (e.g. as storage in a corresponding program). For example, brightness information relating to a color channel “red”, which represents the information about the object characteristic, can be evaluated in order to determine the inspection illumination setting.

Thus, for example, the object 223 can be delimited from the background 240 by means of the object characteristic and/or by means of the object detection, e.g. detection of an outline 270, that is to say a border, of the object. Accordingly, the inspection illumination setting can be determined based on the selected brightness information of the reference recording, e.g. a histogram.

In other words, the object property can be, for example, a property, on the basis of which or with respect to which associated brightness information can be evaluated, or with respect to which illumination parameters (i.e. illumination settings) of an associated recording unit can be optimized.

Further, an example of a result of object detection according to the invention is shown in FIG. 2, wherein the outlines of the rotor blade are highlighted, see border 270. Further, further information can also be determined on the basis of the object detection, such as inclination information 280 relating to the object (e.g. an inclination angle=38), i.e. the rotor blade 223, for example, in the example of FIG. 2, and/or such as color information 290 (displayed at the very top of the image), e.g. in the form of information about dominant color values, as shown here e.g. a display of the dominant red value (number 192) and/or e.g. in the form of information about a color mean value (number 124).

As discussed above, e.g. a first evaluation algorithm, e.g. AI, cannot only detect the outlines 270 of the blade 223, but also the object characteristic “red” and/or the inclination 280.

Such additional information, such as the object characteristic, the outlines 270 and/or the inclination, can be used, for example, to align the recording unit with the object, for example such that the object or the part of the object is in a predetermined image portion.

In other words, a method according to the invention optionally includes generating an initial recording of the object 223, detecting the object in the initial recording and evaluating the initial recording; determining a trigger point for the recording unit for generating the reference recording based on the evaluation of the initial recording so that the object is in a predetermined image portion of the reference recording (for example in the center), and positioning the recording unit at (for example approaching) the trigger point and generating the optical reference recording of the object at the trigger point using the recording unit.

FIGS. 3A-3D show schematic views of an object and a background of the object, FIG. 3A, a section of the view from FIG. 3A in FIG. 3B, as well as schematic plots of brightnesses of color channels for the view from FIG. 3A in FIG. 3C and for the view from FIG. 3B in FIG. 3D, according to embodiments.

FIG. 3A shows an object 320 against a background 340. FIG. 3A can therefore represent, for example, a reference recording. FIG. 3B shows an associated brightness evaluation of the view from FIG. 3A. A brightness of RGB color channels (red 301, green 302 and blue 303) of the view or recording is plotted against respective parts of the color channels (RGB part from 0 to 255:0 for 0% color saturation and 255 for 100% color saturation). As can be seen, the recording thus has a high brightness in a white color range, see peaks 304, and a significantly lower brightness in a grey color range, see peaks 305.

FIG. 3D shows a corresponding plot (RGB color channels, red 301′, green 302′ and blue 303′) for the recording from FIG. 3B, that is to say for the part 320′ of the object 320 and the background section 340′, with the result that the ratios of the brightness peaks 304′ and 305′ are changed here compared to FIG. 3C.

Based on the plots in FIGS. 3C and 3D, it becomes clear that, due to the potentially highly varying image parts of the object 340 or object part 340′ and the background 320, 320′ and their associated brightnesses, predictable and above all sufficient lighting of an object for inspection purposes is not always readily given.

According to embodiments, therefore, brightness information, e.g. information corresponding to the plots in FIGS. 3C and 3D, e.g. brightness and color saturation information, e.g. in the form of histograms, can be determined based on at least one portion of the reference recording, said at least one portion comprising at least one sub-portion of the object (e.g. 223, 320, 320′ ).

The brightness information can therefore include, for example, in particular, only the information in the portions 305 and 305′ of the plots in FIGS. 3C and 3D which are associated with the object or object part.

FIG. 3A also indicates optional additional information 390, e.g. obtained from the object detection. This information optionally includes (shown here as examples): First line: 224=histogram value of complete image (e.g. here of the complete image in FIGS. 3A), 166=histogram of image section in FIG. 3B) or histogram value of image section in FIG. 3B); second line: 220=histogram of red channel or histogram value for red channel of complete image, 164=red channel section in FIG. 3B or histogram value for red channel of image section in FIG. 3B; third line: HSV of the complete image; fourth line: HSV of the red channel.

As shown in FIG. 2, the object can have, for example, an object characteristic (e.g. “red”), and so one or more brightness threshold values can be optionally determined based on the object characteristic. In other words, a corresponding threshold value can be determined, for example, specifically selectively for a red color channel which, for example due to the object characteristic, has a particularly high information content for the representation quality of the object in the recording with regard to an inspection, which threshold value is selected, for example, in such a way that a feature to be inspected of the object can thus be detected with sufficient certainty. For example, the object feature may be damage and/or potential damage to the object, such as cracks, holes, bending, chipped paint.

Such a threshold value can be determined dynamically, for example, in a method according to the invention, e.g. based on machine learning, or can also be stored, for example, as a selection parameter, e.g. in a table, e.g. for selection depending on the object type, additional information or further parameters.

Using a threshold value comparison and, for example, an evaluation of given brightness in comparison with the threshold value, it is possible to adjust the illumination settings which were used for the reference recording, thus making it possible to provide an inspection illumination setting which makes it possible to generate an inspection image recording in an identical or at least similar lighting situation of the object to that for the reference recording, which inspection image recording has a brightness distribution that satisfies the brightness threshold value(s). It should be pointed out once again that upper and lower limit values can be used here, e.g. with regard to avoiding underexposure or overexposure.

However, according to embodiments, threshold values (e.g. upper and lower threshold values in each case) for a plurality of color channels can also be optionally taken into account. As shown in FIGS. 3A-3D, the optical reference recording may comprise a plurality of color channels, wherein the brightness information can be color-specific information about a brightness distribution, and wherein a plurality of color-specific brightness threshold values, for example for the channels red, green and blue, can be determined.

In particular, these threshold values can be determined for a certain saturation ratio (e.g. between 0 and 255) of the color channels, with the result that a specific color channel combination, which describes the object, e.g. the object characteristic in the form of the color of the object, can be used to determine the inspection illumination setting with regard to sufficient brightness.

With reference to FIGS. 3A-3D, it should be noted that in general according to embodiments optionally all pixels of the object in the optical reference recording and/or a contiguous subset of pixels of the object in the optical reference recording, e.g. the object points of the image section in FIG. 3B, and/or a predetermined pattern of pixels of the object in the optical reference recording can be used. For example, the pattern can be selected in such a way that, in particular, portions of the object that are more likely to be damaged can be optimally illuminated. In addition, the number of pixels to be considered can be reduced, in particular with regard to portions that are of little interest or little significance.

Optionally, a method according to the invention can be performed iteratively. For example, the recording unit 110 in FIG. 1 can have a first illumination setting, e.g. a reference illumination setting for generating the reference recording 131, when flying over the object 120. As explained above, based on detected pixels of the object 123′ in the reference recording 131, it is possible to derive brightness information 160 and corresponding threshold values, e.g. based on an object characteristic.

If the brightness information, e.g. peaks 305, 305′ associated with the object, complies with the at least one brightness threshold value, the reference illumination setting can be determined as the inspection illumination setting.

Otherwise, for example, as optional features, based on the comparison result, e.g. a distance or difference between the desired brightness in the form of the threshold value(s) and the actual situation in the reference recording, an adjusted reference illumination setting is determined, e.g. during flight by means of a processor of the recording unit, or by means of an external data processing unit, e.g. a laptop on the ground.

An adjusted reference recording is then generated in order to simulate generation of the reference recording using the adjusted reference illumination setting. Optionally, a further recording 130 can also be generated instead by using the recording unit 110 by means of the adjusted reference illumination setting.

The adjusted reference recording can now in turn be evaluated for object points with regard to brightness threshold values. If the threshold values are complied with, an inspection illumination setting has thus been found, for example, and can be used to make a recording 132, on the basis of which a reliable object inspection is possible.

The adjustment of the illumination setting can, for example, quite generally, according to embodiments, include a change in illumination times and/or a change in aperture settings, e.g. a size of the aperture, such as a change in the aperture.

Specifically, a process according to the invention can thus be described as follows, for example:
1. The object to be inspected is detected in the video stream or single image recording using object detection/AI
2. Then the brightness of the entire object or only part of the object is calculated
   2.1. Determining the color values per pixel in the RGB color space or HSV color space or in the monochrome color space
   2.2. Determining the dominant color channel (red, green, or blue)
   2.3. Calculating limit values according to the dominant color space
3. Evaluating the calculated brightness and load corresponding limit values. Limit values have been determined in advance specifically for the objects.
   3.1. If the brightness is within the limit values->no further changes are needed
   3.2. If the brightness is outside the limit values->continue to 4.
4. The parameters are adjusted according to the limit values of the camera (illumination time/aperture).
   4.1. Above the limit value (too bright)->reduce the illumination time (e.g. 1/500-> 1/1000) or decrease the aperture (e.g. 4.5->5.0)
   4.2 Below the limit value (too dark)->extend the illumination time (e.g. 1/1000-> 1/500) or increase the aperture (e.g. 5.0->4.5)
5. The process begins at 1.

The brightness adjustment can be effected at any time in flight or during hovering of the drone or before each image.

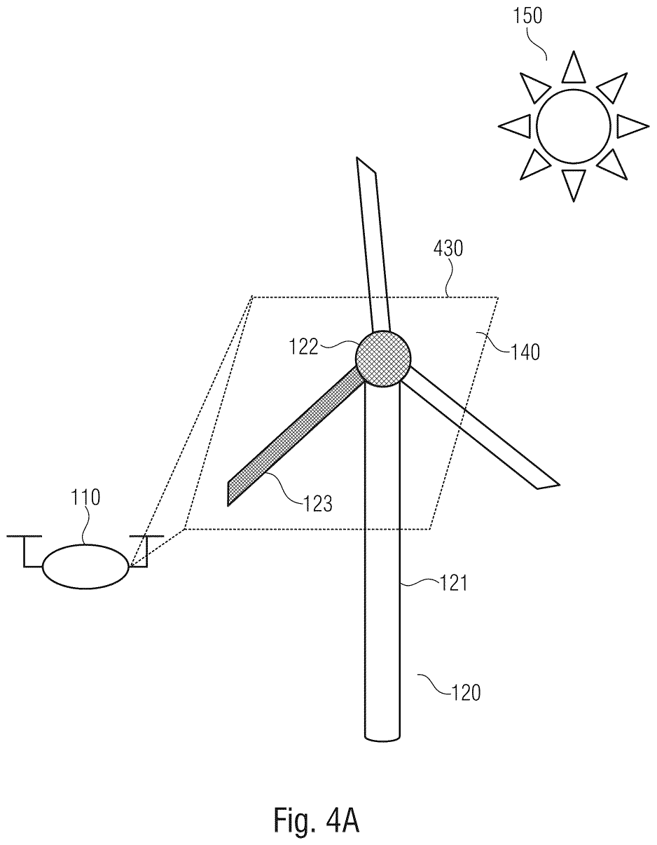

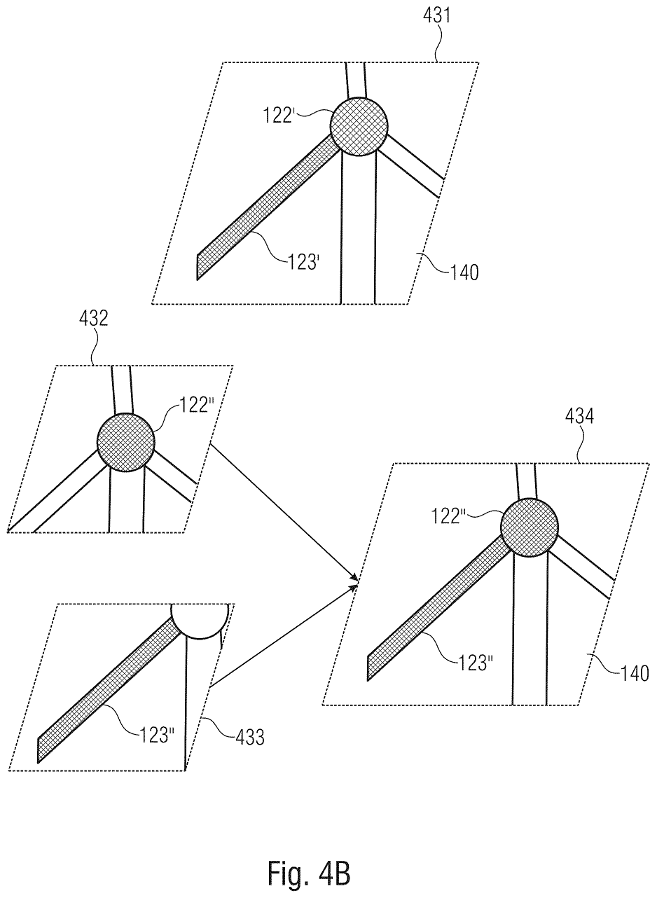

Reference is made to FIGS. 4A and 4B below. FIGS. 4A and 4B show a schematic view of detection of a plurality of objects and schematic representations of optical recordings according to embodiments of the invention.

FIGS. 4A and 4B show in FIG. 4A the recording situation from FIG. 1, wherein the recording unit again makes a recording 430 in a backlighting situation, but the recording comprises both the hub 122 and a rotor blade 123. In the example of FIGS. 4A and 4B, the hub 122 is partially shaded, for example, and the rotor blade 123 is heavily shaded. The remaining installation parts, i.e. the tower and the two other rotor blades, not completely represented in the recording 430, are not shown in FIGS. 4A and 4B with regard to their illumination for simplification.

Optionally, a method according to the invention includes detection of both objects 122 and 123 in the recording 430. The brightness evaluation can then be performed separately or together for each of the two objects.

For example, once the objects 122 and 123 have been identified, separate brightness histograms can be respectively determined, one for object 122 and one for object 123. Based on a respective evaluation, e.g. as previously discussed in the case of a single object or object part, respective inspection illumination settings can thus be determined. Subsequently, respective inspection recordings 432 for object 122 and 433 for object 123 can be recorded. The images 122″ and 123″ are then each recorded with the individually optimized illumination settings. In the schematic representations of the recordings 432 and 433, the illumination situation of the other objects and object parts within the recording is not shown. The other image parts, which for example are not the focus of a subsequent inspection, may be overexposed or underexposed, for example.

In order to avoid such a restriction (that, for example, a plurality of objects or object parts are not optimally lit in a recording), image fusion of the images 122″, 123″ of the objects can be performed, for example, in order to obtain a fusion image 434. For this purpose, the representations 122″, 123″, for example, can be cut out from their respective recordings and inserted into the reference recording 430 as a replacement for the associated image parts.

In this way, any number of image elements, e.g. also the background 140, can be recorded with optimized illumination settings in each case and finally merged. Thus, the inspection can be performed on the basis of a recording with sufficiently illuminated objects in each case.

Another possibility is to find a compromise setting for the inspection illumination either by means of the individual brightness evaluations of the objects 122 and 123 or by means of a joint brightness evaluation of the objects 122 and 123. Based on this, it is possible to make an inspection recording 431 which comprises here as an example representations 122′ and 123′ of both objects, with the result that they are also sufficiently lit for an inspection.

Features of methods according to embodiments are described again below in other words:

According to embodiments, an object (e.g. 122, 123) can be detected from an image (e.g. 131, 430), e.g. with the aid of Al. For example, all pixels of this object can be taken into account in order to calculate the brightness, e.g. to determine brightness information. Subsequently, the illumination values of a camera of a recording unit can be changed based on a threshold value that is defined (or adaptively determined, e.g. with regard to an object characteristic). The brightness calculation can then be performed again, e.g. for an image adjusted according to the changed illumination values. This can be performed or take place, for example, until a required value range is reached. The object can have any shape in the image space. However, there is also the possibility, for example, of not using all pixels of the object, but only certain ones, e.g. from the center of the object (for example 100 px×100 px) or only pixels that follow a certain pattern (for example every 3rd pixel in a row).

Optionally, the color spaces can be viewed individually in order to determine dominant influences in order to adjust the brightness accordingly. (e.g. dominant red channel requires different limit values than everything equally distributed).

The advantage of this is that for inspections the environment outside the object has a smaller influence on the brightness of the image.

This can be extended to HDR (High Dynamic Range) images and a plurality of objects with different brightnesses can be individually recorded with the recording unit, e.g. a camera, and then merged again (e.g. fused) be form an image. Once the correct setting (e.g. inspection illumination setting) has been found for the object, a setting for the background can also be found. These different images can then be merged again.

All enumerations of the materials, environmental influences, electrical properties and optical properties listed herein should be regarded as exemplary here and not as conclusive.

Although some aspects have been described in connection with an apparatus, it goes without saying that these aspects also constitute a description of the corresponding method, and so a block or a component of an apparatus should also be understood as a corresponding method step or as a feature of a method step. Similarly, aspects described in connection with or as a method step also constitute a description of a corresponding block or detail or feature of a corresponding apparatus. Some or all of the method steps can be performed by a hardware apparatus (or using a hardware apparatus), such as a microprocessor, a programmable computer, or an electronic circuit. In some embodiments, some or a plurality of the most important method steps can be performed by such an apparatus.

Depending on specific implementation requirements, embodiments of the invention may be implemented in hardware or software. The implementation can be performed using a digital storage medium, such as a floppy disk, a DVD, a Blu-ray disc, a CD, a ROM, a PROM, an EPROM, an EEPROM or a FLASH memory, a hard disk or another magnetic or optical memory storing electronically readable control signals that may interact with or interact with a programmable computer system in such a way that the respective method is performed. Therefore, the digital storage medium can be computer-readable.

Thus, some embodiments according to the invention include a data carrier comprising electronically readable control signals which are able to interact with a programmable computer system in such a way that one of the methods described herein is performed.

In general, embodiments of the present invention may be implemented as a computer program product with a program code, wherein the program code is effective in performing one of the methods when the computer program product runs on a computer.

For example, the program code can also be stored on a machine-readable carrier.

Other embodiments include the computer program for performing one of the methods described herein, wherein the computer program is stored on a machine-readable carrier.

In other words, one embodiment of the method according to the invention is thus a computer program comprising a program code for performing one of the methods described herein when the computer program runs on a computer.

A further embodiment of the methods according to the invention is thus a data carrier (or a digital storage medium or a computer-readable medium) on which the computer program for performing one of the methods described herein is recorded. The data carrier, the digital storage medium or the computer-readable medium is typically objective and/or non-transitory or non-transient.

A further embodiment of the method according to the invention is thus a data stream or a sequence of signals representing the computer program for performing one of the methods described herein. The data stream or the sequence of signals can be configured, for example, to be transferred via a data communication connection, for example over the Internet.

A further embodiment includes a processing device, for example a computer or a programmable logic device, which is configured or adapted to perform one of the methods described herein.

A further embodiment includes a computer on which the computer program for performing one of the methods described herein is installed.

A further embodiment according to the invention includes an apparatus or a system configured to transmit a computer program for performing at least one of the methods described herein to a receiver. The transmission can be effected electronically or optically, for example. For example, the receiver may be a computer, a mobile device, a storage device, or a similar apparatus. The apparatus or the system may include, for example, a file server for transmitting the computer program to the receiver.

In some embodiments, a programmable logic device (for example a field programmable gate array, an FPGA) may be used to perform some or all of the functionalities of the methods described herein. In some embodiments, a field programmable gate array may interact with a microprocessor in order to perform one of the methods described herein. In general, the methods are performed in some embodiments by any hardware apparatus. This can be universally usable hardware such as a computer processor (CPU) or hardware specific to the method, such as an ASIC.

The apparatuses described herein may be implemented, for example, using a hardware apparatus, or using a computer, or using a combination of a hardware apparatus and a computer.

The apparatuses described herein, or any components of the apparatuses described herein, may be implemented at least in part in hardware and/or software (computer program).

The methods described herein may be implemented, for example, using a hardware apparatus, or using a computer, or using a combination of a hardware apparatus and a computer.

The methods described herein, or any components of the methods described herein, may be performed at least in part by hardware and/or software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Method for adjusting a recording unit for performing an inspection of an object, comprising:
providing an optical reference recording which has been generated by using the recording unit and which comprises at least part of the object to be inspected and an environment of the object;
detecting the object within the optical reference recording;
determining brightness information based on at least one portion of the reference recording, said at least one portion comprising at least one sub-portion of the object;
determining an inspection illumination setting for the recording unit by using the brightness information.

2. Method according to claim 1,
wherein the object comprises an optically capturable object characteristic, such as a color, a pattern and/or a color pattern; and
wherein determining an inspection illumination setting for the recording unit is performed using the brightness information and the object characteristic.

3. Method according to claim 2, wherein the method further comprises:
detecting the optically capturable object characteristic by means of the optical reference recording.

4. Method according to claim 2,
wherein the brightness information comprises information about a brightness distribution of the at least one portion of the reference recording; and
wherein the method further comprises:
determining at least one brightness threshold value based on the object characteristic; and
determining the inspection illumination setting for the recording unit using the brightness information and the at least one brightness threshold value, so that an inspection recording of the object, which is generated by using the recording unit with the inspection illumination setting in an identical or at least similar lighting situation of the object to that for the reference recording, comprises a brightness distribution which satisfies the brightness threshold value.

5. Method according to claim 4,
wherein the method is a method for adjusting a recording unit for performing an inspection of the object with respect to an object feature to be optically detected; and
wherein determining the at least one brightness threshold value based on the object feature to be detected is performed in such a way that the object feature to be detected can be detected by means of the inspection recording of the object.

6. Method according to claim 4,
wherein the optically capturable object characteristic is a color, a color pattern and/or a color distribution of the object;
wherein the optical reference recording comprises a plurality of color channels; and
wherein the brightness information is color-specific information about a brightness distribution; and
wherein determining the at least one brightness threshold value comprises determining one or more color-specific brightness threshold values.

7. Method according to claim 1,
wherein the optical reference recording is based on a reference illumination setting of the recording unit;
wherein the determination of the inspection illumination setting for the recording unit is performed using the brightness information and at least one brightness threshold value, and further comprises:
comparing the brightness information with the at least one brightness threshold value,
wherein, if the brightness information complies with the at least one brightness threshold value, the reference illumination setting is determined as the inspection illumination setting, and
wherein, if the brightness information does not comply with the at least one brightness threshold value, the following steps of
determining an adjusted reference illumination setting using the comparison;
generating an adjusted reference recording in order to simulate generation of the reference recording using the adjusted reference illumination setting;
determining adjusted brightness information based on at least one portion of the adjusted reference recording, said at least one portion comprising at least one sub-portion of the object;
comparing the adjusted brightness information with the at least one brightness threshold value;
are performed iteratively until the adjusted brightness information complies with the at least one brightness threshold value, wherein the adjusted reference illumination setting, by means of which the brightness threshold value is complied with, is then determined as the inspection illumination setting.

8. Method according to claim 1,
wherein the object is a first object, and wherein the optical reference recording comprises a second object; and
wherein the method further comprises:
detecting the second object within the optical reference recording;
determining second brightness information based on at least one portion of the reference recording, said at least one portion comprising at least one sub-portion of the second object;
determining a second inspection illumination setting for the recording unit by using the second brightness information;
generating a first optical inspection recording of the first object by using the recording unit with the inspection illumination setting; and
generating a second optical inspection recording of the second object by using the recording unit with the second inspection illumination setting.

9. Method according to claim 8, wherein the method further comprises:
fusing the first and second optical inspection recording.

10. Method according to claim 1,
wherein the object is a first object, and wherein the optical reference recording comprises a second object; and
wherein the method further comprises:
detecting the second object within the optical reference recording;
determining common brightness information based on the at least one portion of the reference recording, said at least one portion comprising at least one sub-portion of the first object, and based on at least one portion of the reference recording, said at least one portion comprising at least one sub-portion of the second object, and determining a common inspection illumination setting for the recording unit by using the common brightness information; or
determining second brightness information based on at least one portion of the reference recording, said at least one portion comprising at least one sub-portion of the second object, and determining a common inspection illumination setting for the recording unit by using the first and second brightness information; and
generating an optical inspection recording of the first and second object by using the recording unit with the common inspection illumination setting.

11. Method for inspecting an object comprising a method according to claim 1, wherein the recording unit is a movable recording unit; and wherein the method further comprises:
moving the recording unit to the object;
generating the optical reference recording;
generating an inspection recording of the object by using the recording unit with the inspection illumination setting.

12. Method according to claim 11, wherein the method further comprises:
generating an initial recording of the object;
detecting the object in the initial recording and evaluating the initial recording;
determining a trigger point for the recording unit for generating the reference recording based on the evaluation of the initial recording so that the object is in a predetermined image portion of the reference recording; and
positioning the recording unit at the trigger point and generating the optical reference recording of the object at the trigger point using the recording unit.

13. Method according to claim 1,
wherein detecting the object within the optical reference recording is performed by means of a first neural network, and wherein the determination of the inspection illumination setting for the recording unit using the brightness information is performed by means of a second neural network; or
wherein detecting the object within the optical reference recording is performed by means of a neural network, and wherein the determination of the inspection illumination setting for the recording unit using the brightness information is performed by means of a computer vision algorithm; or
wherein detecting the object within the optical reference recording is performed by means of a computer vision algorithm, and wherein the determination of the inspection illumination setting for the recording unit using the brightness information is performed by means of a neural network; or
wherein detecting the object within the optical reference recording is performed by means of a first computer vision algorithm, and wherein the determination of the inspection illumination setting for the recording unit using the brightness information is performed by means of a second computer vision algorithm.

14. Method according to claim 1,
wherein the object is a wind turbine or part of a wind turbine, such as a rotor blade, a rotor blade hub, a rotor blade flange, a tower and/or a nacelle.

15. Method according to claim 14,
wherein the method is a method for inspecting a component of a wind turbine with respect to optically detectable damage and/or potential damage;
wherein the recording unit is a drone; and
wherein the method comprises:
approaching the component of the wind turbine by means of the recording unit;
generating an optical reference recording of the component of the wind turbine by means of the recording unit;
automatically detecting the component of the wind turbine within the optical reference recording;
determining a brightness distribution based on a subset of sampling points of the reference recording comprising the detected component of the wind turbine;
determining an inspection illumination setting for the recording unit using the brightness distribution so that damage and/or potential damage to the component of the wind turbine can be optically detected in an inspection recording of the component of the wind turbine, which is generated by using the recording unit with the inspection illumination setting in an identical or at least similar lighting situation of the component of the wind turbine to that for the reference recording.

16. Apparatus for adjusting a recording unit for performing an inspection of an object, the apparatus comprising:
an evaluation unit which is configured
to acquire an optical reference recording which has been generated by using a recording unit and which comprises at least part of the object to be inspected and an environment of the object;
to detect the object within the optical reference recording;
to determine brightness information based on at least one portion of the reference recording, said at least one portion comprising at least one sub-portion of the object; and
to determine an inspection illumination setting for the recording unit by using the brightness information.

17. Apparatus according to claim 16, further comprising:
the recording unit which is configured to generate the optical reference recording.

18. Apparatus according to claim 17,
wherein the recording unit is a drone for flying over the object; and
wherein the recording unit is configured to perform the reference recording and an inspection recording of the object using the inspection illumination setting without an intermediate landing.

19. Apparatus according to claim 18,
wherein the recording unit comprises the evaluation unit; or
wherein the apparatus comprises a communication unit which is configured to provide the evaluation unit with information about the optical reference recording from the recording unit and to provide the recording unit with information about the inspection illumination setting from the evaluation unit.

20. A non-transitory digital storage medium having a computer program stored thereon to perform the method according to claim 1 when said computer program is run by a computer.
